(19) United States
(12) Patent Application Publication
(10) Pub. No.: US 2009/0043562 A1
(43) Pub. Date: Feb. 12, 2009

(54) METHOD AND APPARATUS FOR RECEIVING AND DISPLAYING A SHORT MESSAGE IN A USER PREFERRED LANGUAGE

(76) Inventors: Vinay Vishwas Peshave, Pune (IN); Eric W B Dias, Bangalore (IN)

Correspondence Address: IBM Corp. (RCR);c/o Rolnik & Associates, P.C., 24 N. Main St., Kingwood, TX, 77339, US

(21) Appl. No.: 11/835,471

(22) Filed: Aug. 8, 2007

(51) Int. Cl. G06F 17/28

(52) U.S. Cl. 704/2

(57) ABSTRACT

A method, apparatus, and computer usable program code for displaying messages in a user-selected language is disclosed. A device receives a message in a sender-selected language. The device translates the message into a user-selected language to form a translated message and renders the translated message on a display.

### BACKGROUND OF THE INVENTION

1. Field of the Invention:

The present invention relates generally to a method, apparatus, and computer usable program code for translating words. More specifically, the present invention permits a user of a device to select a preferred language for translation and translating received messages.

2. Description of the Related Art:

Modern portable devices use data access in a variety of settings. Typically, these settings are outside the office or other workplace. One way to receive data is by paging and other short messaging services. The creation of the Global System for Mobiles in the late 1980's triggered an explosive growth in short message usage through the short messaging system (SMS). Other cellular telephone technology providers quickly adopted similar services as well as provided methods to convert SMS messages or text messages to email.

More advanced wireless systems provide enhanced data rates to portable devices. Portable devices include, for example, mobile telephones, two-way pagers, and notebook computers. Nevertheless, in the developing world, most data access occurs by receiving SMS messages.

A user may compose many SMS messages on a mobile telephone and send them as a single message from a user to another user of a portable device. Additional benefits have accrued where an online provider provides timely information to subscribers who pay a fee for the received messages.

A parallel development to the transport of SMS messages is the development of instant messaging between computer users. Such messages are generally very short, for example, less than 100 characters long. Typically, several messages in a sequence of exchanged messages are displayed within a computer display window.

Unfortunately, many people establish contacts on a fleeting and somewhat impersonal basis. Consequently, a message sender may be unaware of the preferred language of a message recipient. Thus, a need exists to provide to a receiver of a message an opportunity to select a language and have a device translate inbound messages to the receiver's selected language.

### SUMMARY OF THE INVENTION

The present invention provides a method, apparatus, and computer usable program code for displaying messages in a user-selected language. A device receives a message in a sender-selected language. The device translates the message into a user-selected language to form a translated message and renders the translated message on a display.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a data processing system in accordance with an illustrative embodiment of the invention;

FIG. 2 is a network of devices in accordance with an illustrative embodiment of the invention;

FIG. 3A is a flowchart for creating a message in accordance with an illustrative embodiment of the invention;

FIG. 3B shows a message in accordance with illustrative embodiments of the invention;

FIG. 3C shows intermediate forms of a message and a translated message in accordance with an illustrative embodiment of the invention;

FIGS. 4A-4C are flowcharts for translating messages in accordance with illustrative embodiments of the invention; and

FIG. 5 shows a sender device and seven receiver devices in accordance with an illustrative embodiment of the invention.

### DETAILED DESCRIPTION OF THE PREFERRED EMBODIMENT

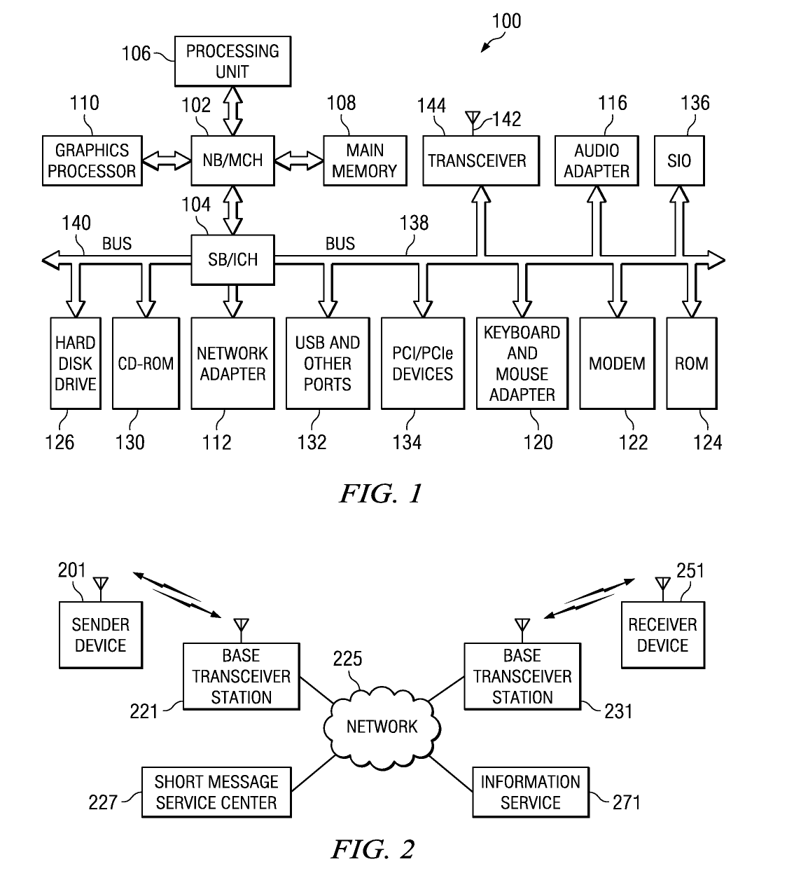

With reference now to the figures and in particular with reference to FIG. 1, a block diagram of a data processing system is shown in which aspects of an illustrative embodiment may be implemented. Data processing system 100 is an example of a computing device, for example a computer, PDA, mobile phone etc., in which code or instructions implementing the processes of the present invention may be located. In the depicted example, data processing system 100 employs a hub architecture including a north bridge and memory controller hub (NB/MCH) 102 and a south bridge and input/output (I/O) controller hub (SB/ICH) 104. Processor 106, main memory 108, and graphics processor 110 connect to north bridge and memory controller hub 102. Graphics processor 110 may connect to the NB/MCH through an accelerated graphics port (AGP), for example.

In the depicted example, local area network (LAN) adapter 112 connects to south bridge and I/O controller hub 104 and audio adapter 116, keyboard and mouse adapter 120, modem 122, read only memory (ROM) 124, hard disk drive (HDD) 126, CD-ROM drive 130, universal serial bus (USB) ports and other communications ports 132, and PCI/PCIe devices 134 connect to south bridge and I/O controller hub 104 through bus 138 and bus 140. PCI/PCIe devices may include, for example, Ethernet adapters, add-in cards, and PC cards for notebook computers. PCI uses a card bus controller, while PCIe does not. Additional connectivity may be available through a transceiver 144, which establishes wireless connectivity via antenna 142 to data networks. Wireless connectivity may be based on, for example, Bluetooth® wireless protocol, cellular standards, or Institute of Electrical and Electronic Engineers (IEEE) 802 series standards, among others. Bluetooth is a trademark of the Bluetooth SIG. ROM 124 may be, for example, a flash binary input/output system (BIOS). Hard disk drive 126 and CD-ROM drive 130 may use, for example, an integrated drive electronics (IDE) or serial advanced technology attachment (SATA) interface. A super I/O (SIO) device 136 may be connected to south bridge and I/O controller hub 104.

An operating system runs on processor 106 and coordinates and provides control of various components within data processing system 100 in FIG. 1. The operating system may be a commercially available operating system such as Microsoft® Windows® XP, Symbian® OS, Microsoft® Mobile OS, Linux™ etc. Symbian is a trademark of Symbian Ltd. Linux is a trademark of Linus Torvalds. Microsoft and Windows are trademarks of Microsoft Corporation in the United States, other countries, or both. An object oriented programming system, such as the Java™ programming system, may run in conjunction with the operating system and provides calls to the operating system from Java™ programs or applications executing on data processing system 100. Java™ is a trademark of Sun Microsystems, Inc. in the United States, other countries, or both.

Instructions for the operating system, the object-oriented programming system, and applications or programs are located on storage devices, such as hard disk drive 126. Instructions may be loaded into main memory 108 for execution by processor 106. The processes of the present invention can be performed by processor 106 using computer implemented instructions, which may be located in a memory such as, for example, main memory 108, read only memory 124, or in one or more peripheral devices.

Those of ordinary skill in the art will appreciate that the hardware in FIG. 1 may vary depending on the implementation. Other internal hardware or peripheral devices, such as flash memory, equivalent non-volatile memory, and the like, may be used in addition to or in place of the hardware depicted in FIG. 1. In addition, the processes of the illustrative embodiments may be applied to a multiprocessor data processing system.

In some illustrative examples, data processing system 100 may be a personal digital assistant (PDA), which is configured with flash memory to provide non-volatile memory for storing operating system files and/or user-generated data. A bus system may be comprised of one or more buses, such as a system bus, an I/O bus, and a PCI bus. Of course, the bus system may be implemented using any type of communications fabric or architecture that provides for a transfer of data between different components or devices attached to the fabric or architecture. A communication unit may include one or more devices used to transmit and receive data, such as a modem or a network adapter. A memory may be, for example, main memory 108 or a cache such as that found in north bridge and memory controller hub 102. A processing unit may include one or more processors or CPUs. The depicted example in FIG. 1 is not meant to imply architectural limitations. For example, data processing system 100 also may be a tablet computer, laptop computer, or telephone device in addition to taking the form of a PDA.

The aspects of the illustrative embodiments provide a method, apparatus, and computer usable program code for discovering a language of a message, and a receiver-selected language in order to select translating instructions. Thus, a sender of a message may rely on an individual recipient's selection of language to permit a correct translation of the text of the message to a language of the receiver. Moreover, a recipient may select profile information without resorting to establishing profile information at an Internet site.

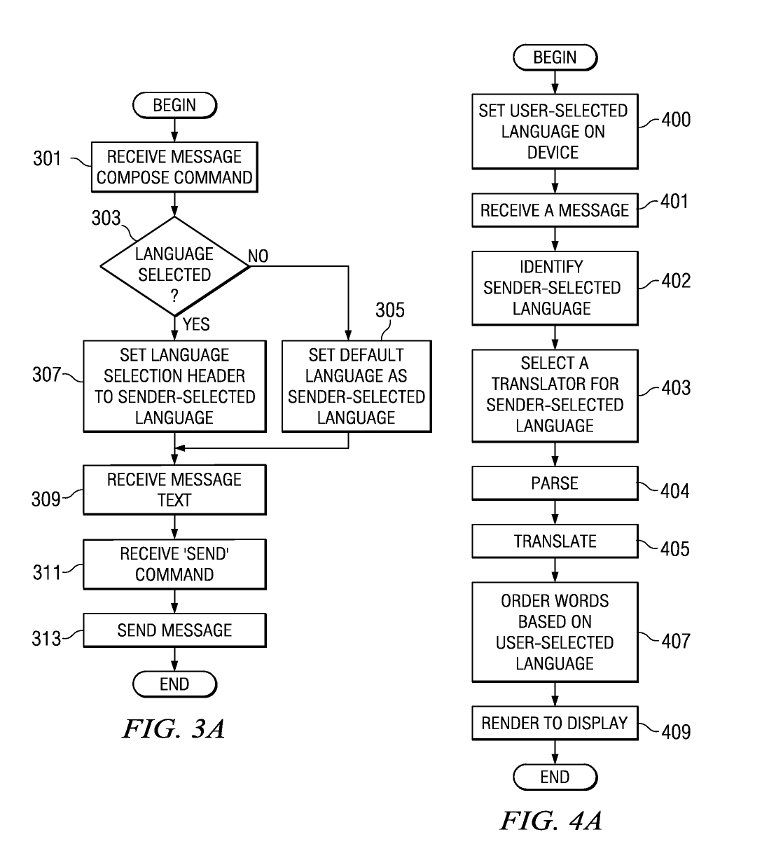

FIG. 2 is a network of devices in accordance with an illustrative embodiment of the invention. Sender device 201 may be a source of a text message. The text message may be, for example, a Short Message Service (SMS) message, a pager message, or other message configured for wireless transport. Sender device 201 exchanges signals including wireless signals of the text message with base transceiver station 221. Base transceiver station 221 may be, for example, a wireless station according to the standards set forth, for example, in Global System for Mobiles standard, Code Division Multiple Access, Third Generation Partnership Project (3GPP), or any other wireless standard. Additional nodes that support wireless and data transmissions may exist within network 225. Network 225 may provide mobile switching nodes, routers, and other infrastructure for data communications. The network may include the Internet.

As a support for short messaging systems, a wireless operator may implement short messaging service center 227. Short Messaging Service Center 227 or SMSC connects to the network and may support billing functions, mobile locating functions, delivery confirmation functions, among other short messaging functions. For example, a short messaging service center may locate an intended recipient of a message, for example, receiver device 251. The SMSC determines that base transceiver station 231 is in radio range with the receiver device. Consequently, SMSC 227 transmits a message via network 225 and via base transceiver station 231 to reach receiver device 251.

Additional messages destined for receiver device 251 may originate from information service 271. Messages may pertain to timely information of a type previously selected by a user. Information service 271 may communicate via network 225 to Short Messaging Service Center (SMSC) 227. SMSC 227 may correlate an email address with a subscriber identity module associated with the receiver device. Having resolved the receiver device 251, SMSC 227 again routes the message via network 225 and base transceiver station 231 to receiver device 251. It is appreciated that the supporting network of FIG. 2 is merely exemplary. Alternative networks include networks wherein the sender device and/or the receiver device connect by wire to one or more routers to permit interconnect between the devices.

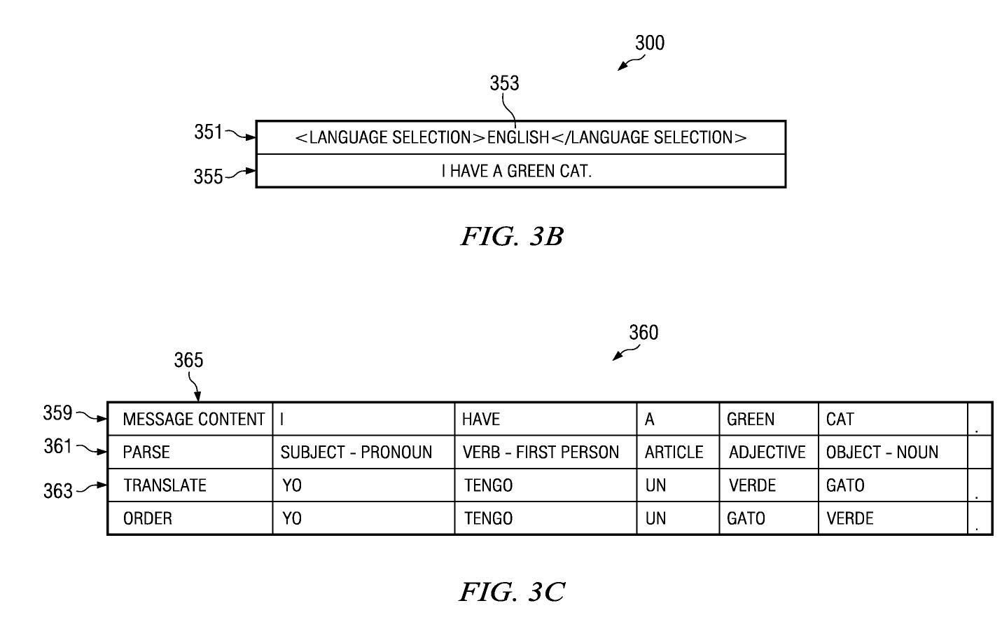

FIG. 3A shows a flowchart of steps that a sender device may execute to produce and transmit a message in accordance with an illustrative embodiment of the invention. Initially the sender device receives a message compose command (step 301). A message compose command may be a predetermined keystroke sequence on a mobile telephone or other portable computing device. The sender device determines whether a language has been selected (step 303). The sender device may check a portion of memory or other allocated storage in support of step 303. The sender checks to determine if the contents therein form a valid sender-selected language or a key corresponding to a sender-selected language.

A sender-selected language is a language of a message selected by a user from a list of standardized language designators. A language designator is, for example, a list of anglicized language names, Internet Engineering Task Force (IETF) language tags, or any other globally recognized language naming convention. A language designator may be a graphic using characters native to the language. A language designator may correspond to International Standards Organization (ISO) 15924. ISO 15924 are codes for the representation of names of scripts. A script is a writing system having sets of graphic characters used for the written form of one or more languages. According to ISO 15924, each script is given both a four-letter code and a numeric code.

A sender device may have a factory-set default selection for the sender-selected language. A sender accepts the default language for the sender device by powering up the device and accepting, without changes, the language that the device first presents to the sender. Thus, a negative result to step 303 prompts the sender device to set the default language as the sender-selected language (step 305).

However, if step 303 is positive, the sender device sets a language selection of a message to the sender-selected language (step 307). A user may enter a language selected from a menu to support step 307.

Processing continues from steps 305 and 307 to step 309. The sender device receives message text (step 309). The sender device may receive text by, for example, keystroke entry, voice recognition, or any other entry method. Next, the sender device receives a send command (step 311). The sender device then sends the message (step 313). The send command may include steps to identify one or more devices or account numbers as destinations to deliver the message. In a first case, a subscriber identity module (SIM) may identify a device. A wireless network operator may assign a telephone number to the SIM, thus providing an easy way to refer to the receiver device. In a second case, an account number may be used to identify a chat user account, such as, for example, AOL Instant Messenger (AIM). The process on the sender's devices terminates thereafter.

FIG. 3B shows a data format of a message 300 in accordance with an illustrative embodiment of the invention. In this case, message content 355 is a short message with Extensible Markup Language (XML) tags. The Extensible Markup Language is defined further in Extensible Markup Language (XML) 1.0 (Second Edition) W3C Recommendation, Oct. 3, 2000, which is herein incorporated by reference. A header 351 is a message portion configured to uniquely identify a standard written language. For example, the header may include a predetermined XML tag pair and a standardized language designator. In this case, standardized language designator 353 is “English.” Message 300 includes at least one word in the sender-selected language in message content section 355.

FIG. 3C shows a table of intermediate forms of a message and associated data during conversion to a user-selected language in accordance with an illustrative embodiment of the invention. A user-selected language is a language that the user of a device selects for receiving incoming messages. In other words, where possible, the illustrative embodiment is requested to convert messages to the user-selected language. This example uses a message content, “I have a green cat” 359. Column 365 includes a description of a step performed to form the text or characters in the adjacent cells. Initially, an assignment of grammar attributes is made in relation to each word in the message content. A parsing step may assign one or more grammar attributes to each word of the message content. A grammar attribute is a descriptive class designation of a word concerning a function that the word may have in a sentence. For example, a grammar attribute may be part of speech, or alternatively, verb tense. In this case, the word “have” has two grammar attributes, namely “verb” and “first person.” Thus, a parse step applied to the message content provides associations 361 of a grammar attribute to each word of message content 359.

Next, each word may be assigned a translation or translated word. A translated word is a word of a language that corresponds to, and means substantially the same as, a word in another language. A word or the translated word may include acronyms and slang words. In this case, an embodiment translates words from English to Spanish. For example, “I” translates to “yo” in Spanish. “Yo” appears among translated words in translated message 363. A translated message is all the translated words that correspond to words of the message.

Further processing of the message may account for differences in word order or presentation format. For example, Spanish places an adjective after the word it modifies. Other languages place words or ideographs in right-to-left as compared to English left-to-right form. A further example of adjusted order of presentation is some Asian languages that place words in a vertical sequence.

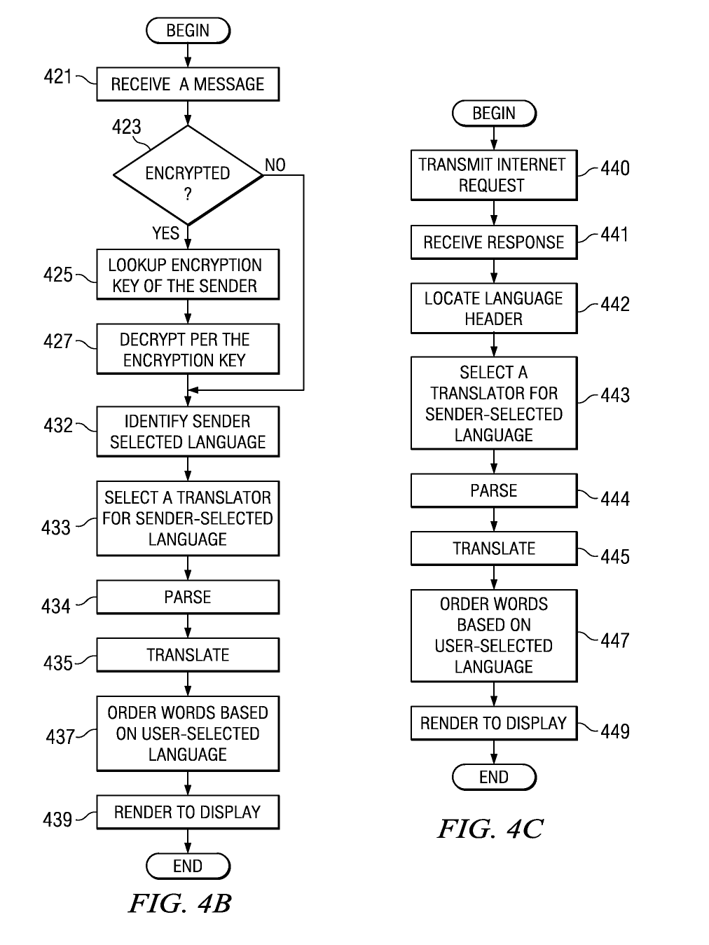

FIG. 4A shows a flowchart of steps of a receiver device in accordance with an illustrative embodiment of the invention. The receiver device may be receiver device 251 of FIG. 2. A display may be coupled to a graphics processor, for example, graphics processor 110 of FIG. 1. Initially, the receiver device sets a user-selected language on the receiver device (step 400). For example, the receiver device may present a user a menu wherein the user may pick from a standardized list of languages. As explained above, the user-selected language may operate as a sender-selected language. Next, the receiver device receives a message (step 401). The message may arrive according to a wireless standard.

A wireless standard may be, for example, Global System for Mobiles (GSM), Code Division Multiple Access (CDMA), Third Generation Partnership Project (3GPP), Third Generation Partnership Project 2 (3GPP2), and the like. Alternative embodiments may receive a message in accordance with email formats. Such formats include, for example, Post Office Protocol 3 (POP3), Internet Message Access Protocol (IMAP), Messaging Application Programming Interface (MAPI), Lotus Domino®, Lotus Notes®, and other email formats. Domino and Lotus Notes are registered trademarks of International Business Machines Corporation.

Next, the receiver device may identify the sender-selected language (step 402). Next, the receiver device selects a translator for the sender-selected language (step 403). For example, a look up table can be created to determine the sender-selected language and the default language of the receiver. If the sender-selected language cannot be determined from the look up table, the receiver device may be configured to add such an entry into the look up table. Alternatively, the receiver device may display the message in the sender-selected language. For example, a mobile phone sold in the Middle East may have Arabic, Hebrew, and English as languages available on the device and a corresponding look up table. If the sender-selected language is Spanish, then the user may configure the device to add the Spanish language dictionary into the device and the look up table may be configured to include Spanish. The look up table may be manually edited by the user or may be automatically configured by the user. Receiver devices may be manufactured according to varying consumer tastes, and accordingly, may have varying amounts of memory. Initially a receiver device may store translators that translate a subset of languages to another subset of languages. Nevertheless, a user may download or otherwise add additional translators to the receiver device. A translator is a software component that provides at least one instruction to convert a word from a first language to a second language. Such an instruction may execute, for example, on a processor of a receiver device. Consequently, the translator can translate from the sender-selected language to the user-selected language.

Next, the receiver device operates instructions to parse a word in the message (step 404). The receiver device assigns a grammar attribute to the word. The receiver device may continue parsing words until all words in the message have been assigned at least one grammar attribute. Parsing may include assessing a function of commas and other punctuation. The receiver device performs step 404 on each word to the extent that the word appears within a dictionary from the sender-selected language to the user-selected language. Next, the receiver device translates each word (step 405). Each word is translated based on the grammar attribute found in step 404 and the translator found in step 403. Words that cannot be found in a dictionary of equivalent terms may not be translated or converted to a phonetic form.

Next, the receiver device applies grammar rules of the user-selected language to order words (step 407). Finally, the receiver device may render the message to a display (step 409). The process terminates thereafter.

FIG. 4B shows a flowchart of steps to translate in accordance with an illustrative embodiment of the invention. A prerequisite of the flowchart is that the sender of a message has previously provided an encryption key to the recipient or the device used by the recipient. A sender authors the message. The sender is a person, or a program executing instructions, or both. Initially, the device receives a message (step 421). The message may include a tag or other indicator that the message is encrypted. An encrypted message may enclose an encrypted portion of the message within XML tags, for example, <encrypted>1si2EkJ % sn39LEf21JSXZn</encrypted>. A sender of the message may encrypt the message using any well known cipher algorithm. Cipher algorithms include classical ciphers, public key ciphers, and private key ciphers, among others. Any additional headers or content may be within the encrypted message. Next, the device determines whether the message is encrypted (step 423). Step 423 may include the device detecting a tag “<encrypted>.” Next, based on a positive outcome to step 423, the device looks up an encryption key of the sender (step 425). Such a look up may be performed by looking up within a database of the device any association of a sender's source address and an encryption key. Source addresses may include, for example, phone numbers, email address, or any other unique address. Next, the device decrypts the message per an encryption key (step 427).

A negative outcome to step 423 results in the device identifying a sender-selected language (step 432). In addition, step 432 follows step 427.

The device performs further steps in a manner comparable to FIG. 4A. Next, the device of FIG. 4B may select a translator based, at least in part, on the sender-selected language (step 433). Next, the device operates instructions to parse a word in the message (step 434). Next, the device translates each word (step 435). Next, the device applies grammar rules of the user-language to order words (step 437). Finally, the device may render the message to the display (step 439). The process terminates thereafter.

FIG. 4C shows a flowchart for translating Internet responses in accordance with an illustrative embodiment of the invention. Initially, a device transmits an Internet request (step 440). An Internet request is a signal transmitted over a network segment that requests a file or a data stream from a host computer. An Internet request may include the application layer types, for example, file transfer protocol (ftp), hypertext transfer protocol (http), or gopher, among others. The device may transmit the Internet request, for example, to information service 271 of FIG. 2. As an example, the device sends a hypertext transfer protocol request. The information service may transmit a hypertext transfer protocol response. The hypertext transfer protocol may be according to the Internet Engineering Task Force RFC 2068 (T. Berners-Lee et al. 1997).

Next, the device receives the response (step 441). The response may include a header field in a form described in relation to the message of FIG. 3B. Consequently, the device may next locate the language header (step 442). Next, the device of FIG. 4C may select a translator based, at least in part, on the sender-selected language (step 443). Next, the device operates instructions to parse a word in the message (step 444). Next, the device translates each word (step 445). Next, the device applies grammar rules of the user-language to order words (step 447). Finally, the device may render the message to the display (step 449). The process terminates thereafter.

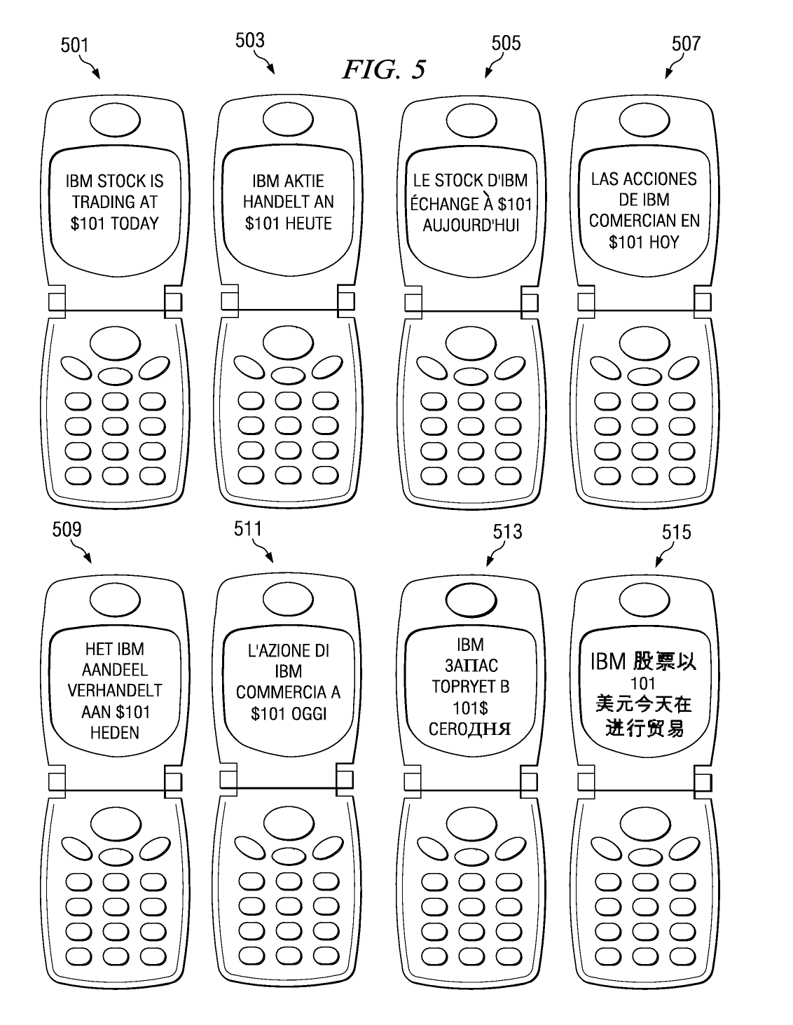

FIG. 5 shows a sender device and seven receiver devices in accordance with an illustrative embodiment of the invention. Sender device 501 may be configured to use a default language of English. The message sent from sender device 501 may be received at receiver devices 503-515. Receiver device 503 translates to German. Receiver device 505 translates to French. Receiver device 507 translates to Spanish. Receiver device 509 translates to Dutch. Receiver device 511 translates to Italian. Receiver device 513 translates to Russian. Receiver device 515 translates to simplified Chinese. The displays of each of these devices may be, for example, LCD, organic LED (OLED), light scanners, and other display devices.

Thus, illustrative embodiments provide a method, apparatus, and computer usable program code to examine received messages and Internet files for a sender-selected language header. Based on the header, the receiver device may convert the received message or file to a language selected by the user or owner of the receiving device.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for displaying messages in a user-selected language comprising:
receiving a message in a sender-selected language;
translating the message into a user-selected language to form a translated message; and
rendering the translated message on a display.

2. The method of claim 1, wherein the message comprises:
a header configured to identify a sender-selected language; and
at least one word in the sender-selected language.

3. The method of claim 2, wherein translating the received message comprises:
identifying the sender-selected language based on the header;
parsing the message to form at least one grammar attribute for the at least one word;
translating the at least one word based on the at least one word, the sender-selected language, and the user-selected language to form at least one translated word; and
ordering the at least one translated word with at least one second translated word to form a translated message.

4. The method of claim 3, wherein receiving comprises wirelessly receiving the message, and the message is a short message transmitted via a short message service center.

5. The method of claim 4, further comprising:
determining whether the message is encrypted;
responsive to a determination that the message is encrypted, looking up an encryption key of a sender; and
decrypting the message based on the encryption key.

6. The method of claim 4, further comprising:
transmitting a hypertext transfer protocol request, wherein the message is a response to the hypertext transfer protocol request.

7. The method of claim 6, wherein the step of translating further comprises:
selecting at least one translator instruction based on the user-selected language and the language of the message; and
operating the at least one translator instruction to translate the at least one word.

8. A data processing system comprising:
a bus;
a storage device connected to the bus, wherein computer usable code is located in the storage device;
a communication unit connected to the bus;
a processing unit connected to the bus, wherein the processing unit executes the computer usable code for displaying messages in a user-selected language, the processing unit further executes the computer usable code to receive a message in a sender-selected language; translate the message into a user-selected language to form a translated message; and render the translated message on a display.

9. The data processing system of claim 8, wherein the message comprises a header configured to identify a sender-selected language; and at least one word in the sender-selected language.

10. The data processing system of claim 9, wherein the computer usable code to display a message comprises computer usable code to:
identify the sender-selected language based on the header;
parse the message to form at least one grammar attribute for the at least one word;
translate the at least one word based on the at least one word, the sender-selected language, and the user-selected language to form at least one translated word; and
order the at least one translated word with at least one second translated word to form a translated message.

11. The data processing system of claim 8, wherein the computer usable code to display a message comprises computer usable code to wirelessly receive the message, and the message is a short message transmitted via a short message service center.

12. The data processing system of claim 9, wherein the processing unit further executes the computer usable code to:
determine whether the message is encrypted;
responsive to a determination that the message is encrypted, look up an encryption key of a sender; and
decrypt the message based on the encryption key.

13. The data processing system of claim 12, wherein the processing unit further executes the computer usable code to transmit a hypertext transfer protocol request, wherein the message is a response to the hypertext transfer protocol request.

14. The data processing system of claim 13, wherein in executing the computer usable code to:
translate the processing unit executes computer usable code to select at least one translator instruction based on the user-selected language and the language of the message; and
operate the at least one translator instruction to translate the at least one word.

15. A computer program product for displaying messages in a user-selected language, comprising:
computer usable program code for receiving a message in a sender-selected language;
computer usable program code for translating the message into a user-selected language to form a translated message; and
computer usable program code for rendering the translated message on a display.

16. The computer program product of claim 15, wherein the message comprises:
a header configured to identify a sender-selected language; and
at least one word in the sender-selected language.

17. The computer program product of claim 16, wherein translating the received message comprises:
computer usable program code for identifying the sender-selected language based on the header;
computer usable program code for parsing the message to form at least one grammar attribute for the at least one word;
computer usable program code for translating the at least one word based on the at least one word, the sender-selected language, and the user-selected language to form at least one translated word; and
computer usable program code for ordering the at least one translated word with at least one second translated word to form a translated message.

18. The computer program product of claim 17, wherein computer usable program code for receiving comprises computer usable program code for wirelessly receiving the message, and the message is a short message transmitted via a short message service center.

19. The computer program product of claim 18, further comprising:
computer usable program code for determining whether the message is encrypted;
computer usable program code for responsive to a determination that the message is encrypted, looking up an encryption key of a sender; and
computer usable program code for decrypting the message based on the encryption key.

20. The computer program product of claim 18, further comprising:
computer usable program code for transmitting a hypertext transfer protocol request, wherein the message is a response to the hypertext transfer protocol request.
